(19) United States
(12) Patent Application Publication
(10) Pub. No.: US 2026/0318372 A1
(43) Pub. Date: Oct. 15, 2026

(54) BRAKE MODULE COMPRISING A HOUSING MADE OF SHEET METAL MOULDED PARTS, AND DRIVE TRAIN COMPRISING SAID BRAKE MODULE

(71) Applicant: Schaeffler Technologies AG & Co. KG, Herzogenaurach (DE)

(72) Inventors: Simon Ortmann, Gütersloh (DE); Doris Maria Wimmer, Ottenhöfen (DE); Alan Barrera Bohorquez, Karlsruhe (DE); Benedikt Grubauer, Neresheim (DE)

(73) Assignee: Schaeffler Technologies AG & Co. KG, Herzogenaurach (DE)

(21) Appl. No.: 19/475,066

(22) PCT Filed: Mar. 15, 2024
(86) PCT No.: PCT/DE2024/100208

§ 371 Date: Oct. 14, 2025

(30) Foreign Application Priority Data
Apr. 18, 2023 (DE) 10 2023 109 656.7

(51) Int. Cl. F16D 55/40; F16D 65/00; F16D 65/18; F16D 121/04; H02K 7/00; H02K 7/102

(52) U.S. Cl. CPC F16D 55/40; F16D 65/0087; F16D 65/186; H02K 7/006; H02K 7/102; F16D 2121/04

(57) ABSTRACT

A brake module includes an axis of rotation, a multi-part housing, an input shaft arranged in the multi-part housing, a braking device arranged in the multi-part housing, and a hydraulic actuating device arranged in the multi-part housing. The multi-part housing includes a first housing part, designed as a sheet metal molded part having a pot shape, and a second housing part, at least partially covering the first housing part and designed as a sheet metal molded part having a lid shape. The braking device includes a first braking partner arranged stationary, and a second braking partner arranged to rotate with the input shaft. The hydraulic actuating device is arranged for actuating the braking device.

### CROSS-REFERENCE TO RELATED APPLICATIONS

This application is the United States National Phase of PCT Appln. No. PCT/DE2024/100208 filed Mar. 15, 2024, which claims priority to German Application No. DE102023109656.7 filed Apr. 18, 2023, the entire disclosures of which are incorporated by reference herein.

### TECHNICAL FIELD

The present disclosure relates to a brake module for a drive train of a vehicle. The disclosure also relates to a drive train comprising the brake module.

### BACKGROUND

The transition from vehicles with internal combustion engines to partially electrified or even fully electrified vehicles is creating new requirements for other components of the drive train. One significant change in at least partially electrified vehicles, for example, is that a recuperation brake is often used in addition to the actual service brake. The service brake is a safety-relevant device that must comply with a number of legal requirements. The recuperation brake, on the other hand, is designed as an optional additional brake, which has advantages over the service brake in terms of energy recovery, wear resistance, etc. In addition, additional brake units can be used, for example to realize a comfort function.

### SUMMARY

The present disclosure proposes a brake module of the type in question which is simple and cost-effective to produce. to the present disclosure also proposes a drive train having the brake module.

Example embodiments of the disclosure arise from the following description and the appended figures.

The disclosure relates to a brake module which is designed and/or is suitable for an electric drive train of a vehicle. In particular, the drive train provides a torque path for transmitting a drive or braking torque to at least one vehicle wheel of the vehicle, the brake module being integrated into the torque path for generating the braking torque. The brake module may be designed as a complementary brake and/or as a supplementary braking device to a service brake and/or recuperation brake, which does not perform any safety-relevant functions but rather a comfort function with regard to the braking of the vehicle. The brake module may serve to brake the vehicle at speeds of less than 20 km/h, in particular less than 15 km/h. In these speed states, the recuperation brake can no longer work effectively, and in particular the brake module is used instead of the service brake. This has the effect that the vehicle is braked to a standstill with little or no noise emission. The service brake can be formed by a disk brake or a drum brake, which is arranged close to the wheel. The recuperation brake can be formed by a drive machine, e.g. an electric machine, in a generator mode. The service brake and the recuperation brake can generate a braking torque together or independently of each other.

The brake module has an input shaft which is designed and/or is suitable for integrating the brake module into the drive torque path of the drive train. In particular, a drive torque from the drive machine can be introduced into the brake module via the input shaft and/or a braking torque can be output from the brake module. The input shaft may form an integral part of the brake module, and the input shaft may be connected to another shaft, e.g. a rotor shaft, a connecting shaft, a transmission shaft, etc., of the drive train via a connection interface, e.g. a spline, in a torque-transmitting manner.

The brake module also includes a braking device which is designed and/or is suitable for generating a braking torque. In particular, the braking device is designed as a friction brake. The braking device has a first braking partner and a second braking partner. The first braking partner is arranged so as to be stationary in the brake module and the second braking partner is connected for conjoint rotation with the input shaft. The first and the second braking partners can interact with each other to generate a braking torque. For example, the first and the second braking partners can come into frictional contact to generate the braking torque. The braking device is designed in particular as a dynamic braking device and/or as a braking device for actuation during driving of the vehicle. In particular, the braking device is not designed as a parking brake or at least not as a mere parking brake.

The brake module has a hydraulic actuating device which is designed and/or is suitable for actuating the braking device. In particular, when the braking device is actuated, the braking torque is generated and the vehicle wheel is braked. The two braking partners may be brought into interaction with each other when the braking device is actuated. The actuating device can be designed as a slave cylinder, e.g., a central release mechanism. The hydraulic actuating device may form part of a hydraulic release system which transmits a pressure generated by a master cylinder to the slave cylinder via a hydraulic pressure line.

The brake module has a multi-part housing in which the input shaft, the braking device and the actuating device are arranged. In particular, the housing defines a housing interior which is sealed in a dust-tight and/or fluid-tight manner. The braking device may be completely received in the housing interior or encapsulated by the housing. In principle, the housing interior can be designed as a dry space, or the housing interior may be designed as a wet space. For this purpose, the wet space is at least partially filled with a temperature-control fluid for lubrication and/or cooling of the braking device. In other words, the braking device is designed as a wet-running or wet friction brake. This design allows the braking device to be operated emission-free by preventing the escape of brake dust and thus fine dust particles. In particular, the housing has a temperature-control inlet and a temperature-control outlet, via which the wet space is connected and/or can be connected to a temperature-control circuit so that the brake heat generated during braking can be dissipated with the temperature-control fluid.

The housing has a pot-shaped first housing part and a lid-type second housing part, the second housing part covering the first housing part at least partially. The first housing part may serve to receive and/or fasten the braking device and the second housing part may serve to receive and/or fasten the actuating device. In particular, the housing is formed substantially from the first and the second housing part. This means that the housing interior is largely or exclusively delimited by the two housing parts. For this purpose, the first housing part and the second housing part may be arranged coaxially and/or concentrically with respect to one another in relation to the axis of rotation. The first and second housing parts can be connected to each other axially in a form-fitting and/or frictional manner with respect to the axis of rotation. In principle, the first and second housing parts can be connected to each other by shaping, e.g. by a flanged or folded connection. The first and second housing parts may be releasably connected to one another via at least one securing means. The securing means may be designed as a screw, pin, retaining ring or the suchlike. The first braking partner may be connected to the first housing part in a torque-transmitting manner and/or for conjoint rotation therewith. Optionally, the temperature-control inlet and/or the temperature-control outlet are arranged in the second housing part.

The first and the second housing part may each be designed as a sheet metal molded part. In other words, the housing is made of sheet metal. In particular, a sheet metal molded part is understood to mean a component which is formed from a metal sheet by means of a forming process and which has a three-dimensional contour. For example, the metal sheet can be formed into the first or second housing part by deep drawing or press forming. The metal sheet may be formed as a steel or aluminum sheet.

The design of the housing parts as sheet metal molded parts allows the housing to be manufactured easily and cost-effectively. In addition, the housing can be made particularly lightweight, which results in an additional weight advantage. Furthermore, functional structures can be easily integrated into the housing parts during the forming process, which on the one hand reduces the variety of parts and on the other hand achieves a high level of functional integration. Furthermore, the two housing parts are formed in one piece so that there are no unnecessary sealing points and the housing therefore has a high degree of sealing tightness, since corresponding sealing measures can be reduced to a minimum.

In an example embodiment, a support contour for axially supporting the first and/or second braking partner is formed on the first housing part by shaping. In particular, the support contour has the function of supporting the first and/or second braking partner or an axial force generated by the actuating device on the housing axially with respect to the axis of rotation when the actuating device is actuated. In principle, the support contour can be formed by a plurality of elevations which are molded in axially with respect to the axis of rotation and which are spaced apart and/or evenly distributed circumferentially. Alternatively, the support contour is formed by a continuous elevation that runs around the axis of rotation and is molded in axially with respect to the axis of rotation. The first housing part is formed substantially from a pot base portion and an adjoining pot wall portion. The support contour may be formed on the pot base portion.

Alternatively or optionally in addition, a connecting contour for the rotationally fixed connection of the first braking partner is formed on the first housing part by shaping. In particular, the connecting contour has the function of supporting the first braking partner or a braking torque generated by the braking device on the first housing part circumferentially with respect to the axis of rotation when the braking device is actuated. The connecting contour can be formed by one or more elevations and/or depressions which are molded radially with respect to the axis of rotation and which are spaced apart and/or evenly distributed circumferentially. The connecting contour may be formed on an inner circumference of the pot wall portion. In particular, the connecting contour is designed as a tooth geometry oriented axially with respect to the axis of rotation.

A first housing part is therefore proposed having a high degree of functional integration. By integrating the support contour and the connecting contour in the first housing part, the braking device can be designed with a reduced number of components, which simplifies the assembly of the braking device and at the same time reduces manufacturing costs.

In a further embodiment, a reinforcement contour for reinforcing the second housing part is formed on the second housing part by shaping. In particular, the reinforcement contour has the function of preventing or reducing deformation of the second housing part or the housing when the braking device is actuated due to the introduced braking torque and/or axial force. The reinforcement contour can be formed by a plurality of elevations and/or depressions which are molded axially and radially with respect to the axis of rotation and which are spaced apart and/or evenly distributed circumferentially. In principle, the second housing part can be designed as a planar and/or flat cover, the reinforcement contour being molded axially with respect to the axis of rotation in part. The second housing part may be designed as a top-hat-shaped cover, which is formed substantially from a cylinder base portion having an adjoining cylinder wall portion and an adjoining collar portion. The reinforcement contour may be formed on the cylinder base portion and/or the cylinder wall portion and/or the collar portion. In particular, the reinforcement contour is formed by a plurality of reinforcement ribs distributed circumferentially. A second housing part is thus proposed having simple and cost-effective production from sheet metal and at the same time a stable structure.

In a further development, the brake module has at least or exactly one sealing device which is designed and/or is suitable for fluid-tight sealing of the input shaft with respect to the housing. In particular, the sealing device is used to dynamically seal the housing interior, in particular the wet space, of the housing during rotation of the input shaft. The sealing device may be designed as a rotary seal, e.g., as a radial shaft sealing ring. The input shaft for integrating the brake module into the drive train may be guided out of the housing interior via the sealing device. For this purpose, the first or the second housing part has a shaft passage through which the input shaft, e.g., the connection interface, is guided out of the housing. The shaft passage can be formed either in the pot base portion of the first housing part or the cylinder base portion of the second housing part.

According to this further development, a sealing seat for the sealing device is formed on the first and/or second housing part by shaping. In particular, the sealing device is arranged on and/or fixed to the sealing seat axially and/or radially in a form-fitting and/or frictional manner. For this purpose, the sealing seat has at least one radial contact surface for the radial contact of the sealing device and optionally an axial contact surface for the axial contact of the sealing device. In particular, the sealing seat is formed in the region of the shaft passage. For example, the sealing seat can be formed by a molded-in annular shoulder, which forms both the axial contact surface and the radial contact surface for the sealing device. By integrating the sealing seat on the first or second housing part, the degree of tightness of the housing and the degree of functional integration can be further increased.

In a further specification, the brake module has at least or exactly one bearing device which is designed and/or is suitable for rotatable mounting of the input shaft relative to the housing. In particular, the bearing device is used to radially support the input shaft on the housing. The brake module may have exactly one sealing device and exactly one bearing device, the input shaft being radially supported via the sealing device on one housing part, e.g., the first housing part, and via the bearing device on the other housing part, e.g., the second housing part. In principle, the bearing device can be designed as a plain bearing. However, the bearing device may be designed as a rolling bearing, e.g., a deep groove ball bearing. The input shaft may be supported radially within the housing interior for rotatable mounting via the bearing device. For this purpose, the first or second housing part has a shaft receptacle in which a bearing point of the input shaft is received. The shaft receptacle can be formed either in the pot base portion of the first housing part or the cylinder base portion of the second housing part.

According to this specification, a bearing seat for the bearing device is formed on the first and/or second housing part by shaping. In particular, the bearing device is arranged and/or fixed axially and/or radially to the bearing seat in a form-fitting and/or frictional manner. For this purpose, the bearing seat has at least one radial contact surface for the radial contact of the bearing device and optionally an axial contact surface for the axial contact of the bearing device. In particular, the bearing seat is formed in the region of the shaft receptacle. For example, the bearing seat can be formed by a molded-in annular shoulder, which forms both an axial contact surface and a radial contact surface for the bearing device. By integrating the bearing seat on the first or second housing part, the degree of functional integration of the housing can be further increased and, at the same time, simple and cost-effective mounting can be realized using only one bearing device.

In a further implementation, the brake module has a flange-like third housing part which is designed and/or is suitable for fastening the housing to a component of the drive train. In particular, the third housing part is used to fasten the housing to a housing portion of the drive train, e.g., the drive machine. The third housing part may be fixed to the component of the drive train in such a way that the braking torque and/or the axial force is and/or can be introduced into the component of the drive train. For this purpose, the third housing part may be installed axially and/or circumferentially with respect to the axis of rotation in a form-fitting manner on the third housing part. For example, the third housing part can be connected to the drive train component via a form-fitting connection and/or a screw connection. In particular, the third housing part is designed as a radially outwardly directed and/or annular flange.

According to this implementation, the third housing part is designed as a sheet metal molded part and/or is connected to the first housing part by shaping. In particular, “joined together by shaping” is to be understood as meaning that the first and third housing parts are joined together by shaping, e.g., in accordance with DIN 8593. The first housing part and the third housing part may be connected to one another via one or more clinch connections. In particular, the clinch connection forms the form-fitting connection by which the housing is connected to the drive train component, e.g., for conjoint rotation therewith. The first and third housing parts may be arranged coaxially and/or concentrically with respect to one another in relation axis of rotation and are connected to one another axially in relation to the axis of rotation. In particular, the third housing part is connected to the first housing part by shaping in the region of the pot base portion of the first housing part. A housing is thus proposed which, by means of the third housing part, forms an assembly which, on the one hand, can be easily adapted to the housing portion and, at the same time, retains its structural integrity even without being installed on the housing portion or is held together as a structural unit.

In a further implementation, the second housing part has the shaft receptacle, as already described above. The brake module has a lid-type fourth housing part, which is designed and/or is suitable for sealing the shaft receptacle. In particular, the fourth housing part together with the second housing part is used to axially delimit the housing interior, e.g., the wet space. Optionally, the fourth housing part is used to fix the bearing device axially with respect to the axis of rotation. The fourth housing part may be fixed and/or can be fixed in the shaft receptacle in such a way that the housing interior is sealed in a fluid-tight and/or dust-tight manner.

According to this implementation, the fourth housing part is designed as a sheet metal molded part. In principle, the fourth housing part can be connected to the second housing part by shaping. The fourth housing part may be fixed in the shaft receptacle in a captive manner, e.g., at least axially in a form-fitting and/or frictional manner. In principle, the fourth housing part can be held in the shaft receptacle in a self-retaining manner, e.g., by a frictional connection. Alternatively or optionally in addition, the fourth housing part is held in the shaft receptacle by a further securing means, e.g., a retaining ring. The fourth housing part may be supported in the shaft receptacle in a fluid-tight manner via a sealing means. For example, the sealing means can be formed by an elastomeric or elastic sealing material, which is optionally applied to the second housing part or the fourth housing part. Alternatively, however, the sealing means can also be formed by a sealing ring, for example an O-ring or the suchlike. In particular, the fourth housing part is formed as a plug or lid. A housing is thus proposed having a high degree of sealing of the housing interior, e.g., the wet space, and at the same time ensuring a secure seat of the bearing device.

In a further implementation, the braking device is designed as a multi-disk brake. The first braking partner includes an outer disk carrier having a plurality of outer disks. In principle, the outer disks can engage directly with the connecting contour of the first housing part for conjoint rotation therewith. In other words, the first housing part forms the outer disk carrier. Alternatively, the outer disks are connected via the outer disk carrier for conjoint rotation with the connecting contour of the first housing part. Alternatively or optionally in addition, the second braking partner includes an inner disk carrier having a plurality of inner disks. Alternatively or optionally in addition, the inner disks can be directly engaged for conjoint rotation with the input shaft. In other words, the input shaft forms the inner disk carrier. Alternatively, the inner disks are connected via the inner disk carrier for conjoint rotation with the input shaft. When the braking device is actuated, the inner disks and outer disks are displaced axially relative to one another due to the axial force generated by the actuating device and are brought into frictional contact so that the inner disks rotate relative to the outer disks around the axis of rotation with friction or are held in a rotationally fixed manner in the case of a complete frictional connection. For this purpose, either the outer disks or the inner disks can be designed as friction disks. The inner disks and the outer disks may be axially displaceable and arranged alternately one behind the other.

According to this implementation, the outer disk carrier and/or the inner disk carrier is designed as a further sheet metal molded part. In particular, the outer disk carrier and the inner disk carrier are manufactured in one piece, in particular from a metal sheet, by shaping. The multi-disk brake may be designed as a wet-running multi-disk brake, and the multi-disk brake, in particular the outer disks and the inner disks, is in physical contact with the temperature-control fluid or run in the temperature-control fluid. The wet multi-disk brake has positive acoustic behavior. Any braking noise that may occur especially in dry braking systems is avoided, which improves the operating behavior. In addition, the sheet metal design allows for simple and cost-effective implementation of the brake module.

Optionally, the braking device has at least one return spring which is designed to move the inner disks and the outer disks into a basic position relative to one another by means of spring force. The basic position usually corresponds to a “normally open” operating state of the multi-disk brake, which means that, when not actuated, the inner disks and the outer disks are released from each other by the return spring. For example, the return spring can be supported directly between two adjacent inner disks or outer disks in order to move them into the basic position when the braking device is not actuated. For example, the return spring can be formed by a compression spring, in particular a helical spring, wave spring, disk spring or the suchlike.

In a further embodiment, the actuating device has an annular housing and an annular piston which is movable axially relative to the annular housing with respect to the axis of rotation. A pressure chamber is formed between the annular housing and the annular piston so that, when hydraulic fluid is supplied into the pressure chamber, the axial force can be transmitted via the ring piston to one of the braking partners. In particular, the actuating device is designed as a concentric slave cylinder (CSC). When the actuating device is actuated, the pressure on the hydraulic fluid is increased, and the axial force is generated due to the increasing pressure in the pressure chamber and is transferred to the annular piston so that it is disengaged axially. The annular piston and the annular housing may be arranged coaxially and/or concentrically with respect one another in relation to the axis of rotation, the pressure chamber being designed as an annular space running around the axis of rotation, which annular space is delimited axially and radially, on the one hand, by the annular piston and, on the other hand, by the annular housing. In particular, the annular piston is arranged radially inside the annular piston and/or supported radially with respect to the axis of rotation on an inner circumference of the annular housing. The annular housing may have a central through-opening, in particular a bore, through which the input shaft is guided at least partially when the actuating device is installed in the housing.

According to this embodiment, the annular piston is designed as a sheet metal molded part. In particular, the annular piston is manufactured in one piece, in particular from a metal sheet, by shaping. The annular piston may be cylindrical and/or Z-shaped when viewed in cross-section and/or rotationally symmetrical with respect to the axis of rotation. In principle, the annular piston can be supported axially directly on one of the braking partners, e.g., one of the outer disks. Alternatively, the annular piston is supported axially in relation to the axis of rotation by at least one pressure piece, e.g., a pressure pot, on one of the braking partners, e.g., one of the outer disks. In principle, the pressure piece can be made of a solid material, e.g. plastic or cast metal. Alternatively, the pressure piece can also be designed as a sheet metal molded part. A brake module is thus proposed which can be manufactured particularly easily and cost-effectively by using sheet metal components produced by shaping.

The present disclosure also relates to an electric drive train of a vehicle having the drive machine and the brake module, as already described above. The drive machine has a stator and a rotor, the rotor being at least indirectly connected to the input shaft of the braking device in a torque-transmitting manner. The rotor of the drive machine, in particular the rotor shaft, and the input shaft of the brake module may be arranged coaxially with respect to the axis of rotation and/or may be connected to one another for conjoint rotation. In other words, the input shaft is operated at the engine speed of the drive machine.

In particular, the vehicle is designed as a hybrid vehicle or as a purely electric vehicle. The vehicle is realized, for example, as a passenger car, minibus, van or the suchlike. The vehicle may be assigned to class M1 or N1 according to Regulation (EU) 2018/858. In particular, the vehicle is designed as a road vehicle and/or is approved and/or is suitable for road transport. For example, the vehicle can reach a maximum speed of more than 80 km/h, more than 120 km/h or more than 140 km/h. Alternatively, the vehicle is designed as a rail vehicle.

It is also possible for the electric drive machine to be the only traction machine for the vehicle. Alternatively, the vehicle has additional traction machines, for example additional electric drive machines and/or an internal combustion engine to generate the drive torque. The drive arrangement may provide at least 20%, at least 40% or at least 80% of the drive torque for the vehicle. The electric drive machine can be assigned to a single driven wheel of the vehicle and/or be designed as a single-wheel drive. Alternatively, the electric drive machine is assigned to two driven wheels, e.g., of a common axle, and/or is designed as an electric axle. In other embodiments, the electric drive machine can also be assigned to all driven wheels and/or wheels of the vehicle and/or be designed as an all-wheel drive.

Optionally, the drive train can have a transmission gearing which is designed and/or is suitable for transmitting the drive torque. There may be a transmission from fast to slow, also known colloquially as a step-down. The transmission gearing is designed to output a converted drive torque based on the drive torque from the electric drive machine in the direction of the at least one driven wheel of the vehicle. For example, the transmission gearing has a transmission output via which the converted drive torque is output in the direction of the at least one driven wheel of the vehicle. The brake module may be arranged on a side of the drive machine facing away from the transmission gearing. Simply put, the brake module can be arranged on one side of the drive machine and the transmission gearing can be arranged on the other side of the drive machine. From a drive technology perspective, the electric drive machine in this further development is arranged between the brake module and the transmission gearing. This arrangement makes it easy to integrate the brake module since there is no need to intervene in the drive torque path.

### BRIEF DESCRIPTION OF THE DRAWINGS

Further features, advantages and effects of the disclosure result from the following description of exemplary embodiments and the attached figures. In the drawings:

FIG. 1 shows a schematic representation of a drive train with a brake module for implementing a comfort brake function as an exemplary embodiment;

FIG. 2 shows a sectional representation of the brake module of FIG. 1;

FIG. 3 shows a detailed view of the sectional representation from FIG. 2;

FIG. 4 shows a perspective front view of the brake module from FIG. 2; and

FIG. 5 shows a perspective rear view of the brake module from FIG. 2.

### DETAILED DESCRIPTION

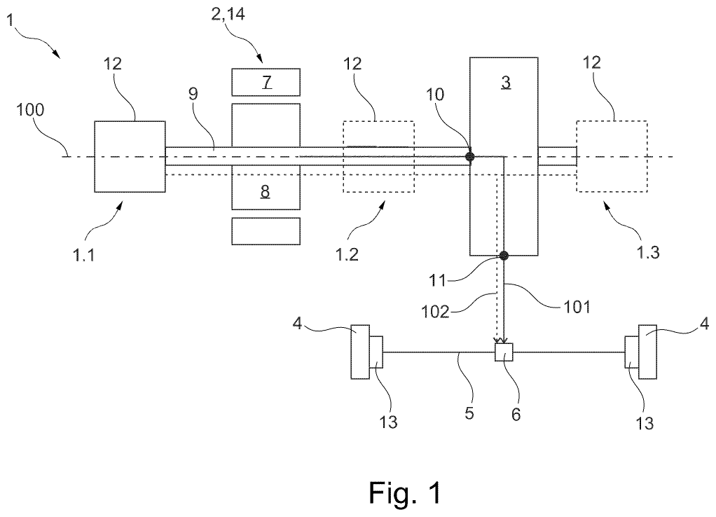

FIG. 1 shows a schematic block diagram of a drive train 1 for a vehicle, which may be, for example, a passenger car, in particular an electric vehicle.

The drive train 1 has an electric drive machine 2, which is designed to generate a drive torque for the vehicle. The electric drive machine 2 is designed as an electric machine, in particular a traction machine, which can be operated both as an electric motor and as a generator.

The drive train 1 also has a transmission gearing 3, which is designed to convert the drive torque from the drive machine 2. In particular, the transmission gearing is used to convert “to slow”. In other words, the transmission gearing 3 has a transmission ratio of (i)>1.

In the exemplary embodiment shown, the drive train 1 has exactly two driven wheels 4 of a drive axle 5, the drive torque converted by the transmission gearing 3 being directed towards the driven wheels 4 and distributed among the two wheels 4 via a differential gearing 6. Alternatively, however, the drive train 1 can also be designed as a single-wheel drive, not shown, the converted drive torque being directed directly to one of the wheels 4.

The electric drive machine 2 includes a stator 7 and a rotor 8, the rotor 8 being connected for conjoint rotation with a rotor shaft 9. The rotor shaft 9 defines an axis of rotation 100 about which the rotor shaft 9 or the rotor 8 rotates relative to the stator 7 during drive operation.

The transmission gearing 3 has a transmission input 10 and a transmission output 11, the rotor shaft 9 being drive-coupled to the transmission input 10. A drive torque path 101 is formed, which runs from the drive machine 2 via the transmission input 10 into the transmission gearing 3 and via the transmission output 11 to the driven wheels 4. The rotational speed at the transmission output 11 is lower than at the transmission input 10.

Optionally, a separating clutch, not shown, can be provided, which is designed to separate the drive torque path 101 after the drive machine 2. This allows the drive machine 2 to rotate without any drive torque being transferred to the driven wheels 4. For example, the separating clutch can be arranged in the drive torque path 101 before the transmission input 10 or after the transmission output 11.

The drive arrangement 1 has a brake module 12 which is designed to generate a braking torque for the driven wheels 4 and to transmit it to the driven wheels 4 via a braking torque path 102. The brake module 12 is designed as a dynamic brake and can brake the vehicle 1 as intended from a driving speed, for example greater than 20 km/h, to a standstill.

As shown in FIG. 1, the brake module 12 can be arranged at different positions of the drivetrain 1 such that the braking torque path 102 runs via the transmission gearing 3, and the brake module 12 is arranged with respect to the braking torque path 102 in front of the transmission gearing 3 in the torque flow direction of the braking torque.

In principle, the brake module 12 is arranged in front of the electric drive machine 2, as shown in arrangement 1.1. The braking torque path 100 thus runs from the brake module 12 via the electric drive machine 2, the transmission gearing 3 and the differential gearing 6 to the driven wheels 4.

Alternatively, the brake module 12 can be arranged between the drive machine 2 and the transmission gearing 3, as shown in arrangement 1.2. The braking torque path 102 thus runs from the brake module 12 via the transmission gearing 4 and the differential gearing 6 to the driven wheels 4. The drive machine 2 is arranged outside the braking torque path 102.

Alternatively, however, the brake module 12 can also be arranged on a side of the transmission gearing 2 facing away from the drive machine 2, as shown in arrangement 1.3. The braking torque path 102 thus runs from the brake module 12 via the transmission gearing 3 and the differential gearing 6 to the driven wheels 4. The drive machine 2 is thus arranged outside the braking torque path 102.

The arrangements 1.1, 1.2, 1.3 of the brake module 12 have in common that the brake module 12 is at least indirectly connected to the rotor shaft 9 in a torque-transmitting manner so that the brake module 12 is operated at the engine speed of the drive machine 3. For this purpose, the brake module 12 is arranged coaxially with respect to the rotor shaft 9 or the axis of rotation 100.

In addition to the brake module 12, the drive train 1 has a service brake 13 close to the wheels, which is designed to brake the two wheels 4, preferably all wheels of the vehicle. For example, the service brake 13 is designed as a disk brake or as a drum brake. With the service brake 13, the vehicle has an approved deceleration system. The brake module 12 is designed, for example, as a complementary brake and/or as a supplementary brake to the service brake 13 which does not perform any safety-relevant functions but rather a comfort function with regard to the braking of the vehicle.

The drive train 1 optionally has a recuperation brake 14, which is implemented by the drive machine 2 in a generator mode. The recuperation brake 14 can be common to, but also independent of, the service brake 13.

The vehicle may have a brake control unit, not shown, which is designed to control the brake module 12, the service brake 13 and optionally the recuperation brake 14. For example, in a comfort braking state, the brake module 12 and the service brake 13 can be controlled in such a way that the braking torque is generated primarily or exclusively by the brake module 12, in particular at lower speeds below 20 km/h. Optionally additionally, the recuperation brake 14 can support the comfort braking state.

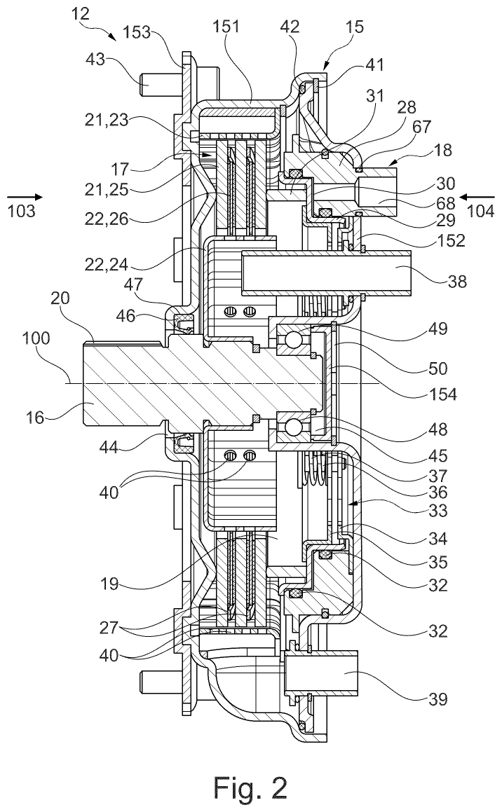

FIG. 2 shows a specific implementation of the brake module 12 as an exemplary embodiment of the invention. The brake module 12 includes a multi-part housing 15 in which an input shaft 16, a braking device 17 and an actuating device 18 are arranged.

The input shaft 16 is, on the one hand, arranged partially within a housing interior 19 of the housing 15 and, on the other hand, is partially guided out of the housing interior 19 with a connection interface 20, the input shaft 16 being connected and/or connectable via the connection interface 20 to the rotor shaft 9 in a torque-transmitting manner or for conjoint rotation therewith. The connection interface 20 is formed, for example, by a tooth system, in particular an external tooth system, the connection interface 20 being connected via a counter-interface, in particular an internal tooth system, correspondingly formed on the rotor shaft 9. The input shaft 16 is thus arranged coaxially with respect to the axis of rotation 100.

The braking device 17 has a first and a second braking partner 21, 22, which are arranged coaxially with respect to the axis of rotation 100 and can be brought into operative connection with one another in order to generate the braking torque. The first braking partner 21 is connected for conjoint rotation with the housing 15 and the second braking partner 22 is connected for conjoint rotation with the input shaft 16. The braking device 17 is designed as a wet, in particular wet-running multi-disk brake, the first braking partner 21 having an outer disk carrier 23 and a plurality of, in particular three, outer disks 25, and the second braking partner 22 having an inner disk carrier 24 and a plurality of, in particular two, inner disks 26, which rotate in a temperature-control fluid, e.g. an oil, located in the housing interior 19. For this purpose, the housing interior 19 is designed as a wet space. The outer and inner disks 25, 26 are displaceable relative to one another axially with respect to the axis of rotation 100 and are fixed circumferentially in a rotationally fixed manner to the plate carrier 23, 24. The outer and inner disks 25, 26 are in frictional contact with one another in an actuated state and are disengaged in an unactuated state. For example, the outer disks 25 can be designed as steel disks and the inner disks 26 as friction disks.

The braking device 17 also includes two return springs 27 which are axially supported between two adjacent outer disks 25 in order to return the outer disks 25 to a predefined basic position in the unactuated state. The return springs 27 apply an axial return force 103 to the outer disks 25. In the basic position, the outer disks 25 are kept spaced apart from each other so that there is sufficient space for free rotation of the inner disks 26 and the air gap. For example, the return springs 27 are each formed by a wave spring.

The actuating device 18 has an annular housing 28 and an annular piston 29 arranged radially inside the annular housing 28, which are arranged coaxially with respect to the axis of rotation 100 and together delimit a pressure chamber 30. The annular housing 28 and the ring piston 29 are designed such that the pressure chamber 30 is delimited axially and radially with respect to the axis of rotation 100, on the one hand, by the annular housing 28 and, on the other hand, by the annular piston 29. For this purpose, the annular piston 29 is designed as a stepped piston, with the annular housing 28 being correspondingly stepped.

The actuating device 18 is designed as a hydraulic central release mechanism, also known as a “concentric slave cylinder”, and the annular piston 29 actuates the braking device 17 in such a way that it can be transferred from the unactuated state to the actuated state. For this purpose, the annular piston 29 is supported axially with respect to the axis of rotation 100 via a pressure piece 31, in particular a pressure cylinder, on one of the outer disks 25, and the annular piston 29 disengages when the pressure chamber 30 is subjected to hydraulic pressure and transmits an axial force 104 to the braking device 17. The pressure chamber 30 is sealed axially by two piston seal rings 32, via which the annular piston 29 is supported in a sealing manner radially on the annular housing 28, and the two piston sealing rings 32 are each fixed to the annular housing 28.

Furthermore, the actuating device 19 has a return unit 33 which is designed to return the annular piston 29 to a starting position in the pressureless, unactuated state or to hold it in this position in order to ensure the air gap between the outer and inner disks 25, 26. The return unit 33 includes an annular first support part 34 for axial support on the annular housing 28 and a second annular support part 35 for axial support on the annular piston 29, which are axially movable relative to one another. For this purpose, the two support parts 34, 35 are resiliently supported against each other axially via a plurality of connecting elements 36 and a plurality of spring elements 37. The spring elements 37 are used to generate or co-generate the return force 103, which acts on the annular piston 29 axially with respect to the axis of rotation 100. The connecting elements 36 can be formed by a plurality of spring rivets which are distributed circumferentially and which are fixed to the first support part 35. The spring elements 37 can be formed by a plurality of helical compression springs arranged coaxially with respect to the spring elements 37. The spring elements 37 are supported, on the one hand, on the spring element 37 and, on the other hand, on the second support part 35.

Furthermore, the brake module 12 has a temperature-control inlet 38 and a temperature-control outlet 39, via which the temperature-control fluid can be supplied into the housing interior 19 or dissipated from the housing interior 20. In particular, the housing interior 19 can be flushed with the temperature-control fluid so that heat resulting from the braking energy can be dissipated and supplied to other locations in the vehicle, e.g. as a passive heating device. For this purpose, the temperature-control inlet 38 opens in the housing interior 19 radially inside the inner disk carrier 24 and the temperature-control outlet 39 opens in the housing interior 19 radially outside the outer disk carrier 23 or in a bottom region of the housing 15. The inner disk carrier 24 and the outer disk carrier 25 each have a plurality of radial fluid openings 40 in order to supply or dissipate the inflowing temperature-control fluid directly to the contact region of the outer and inner disks 25, 26. During braking operation, the temperature-control fluid thus flows from the inside or from the temperature-control inlet 38 via the fluid openings 40 through the inner disk carrier 22, the disk pack 25, 26 and via the fluid openings 40 through the outer disk carrier 23 to the outside or to the temperature-control outlet 39.

The present disclosure improves the previously described basic structure of the brake module 12 with regard to the variety of parts and costs. The aim is to achieve a high degree of functional integration, and the assembly of the brake module 12 is to be designed in such a way that it forms a closed structural unit which retains its structural integrity even when not installed as intended. For this purpose, it is proposed that the housing 15 be constructed in four parts from the housing parts 151, 152, 153, 154.

The first housing part 151 is substantially pot-shaped and the second housing part 152 is substantially in the form of a lid, and the first and the second housing part 151, 152 are connected to one another axially with respect to the axis of rotation 100 via a form-fitting connection in order to delimit the housing interior 19. For this purpose, the brake module 12 has a securing means 41, e.g. a retaining ring, and a sealing ring 42, e.g. a shaped ring, via which the second housing part 151 is installed in the first housing part 152 in a fluid-tight manner.

The third housing part 153 is designed to be flange-like, and the first and third housing parts 151, 152 are connected to one another axially with respect to the axis of rotation 100 by shaping in order to fasten the brake module 12 to a housing portion, not shown, of the drive machine 2 or the transmission gearing 3, depending on the arrangement 1.1, 1.2, 1.3. The third housing part 153 has a plurality of fastening means 43, e.g. screws, distributed circumferentially, by means of which the third housing part 153 can be axially fixed to the housing portion.

The first housing part 151 has a central shaft passage 44, e.g. a through-bore, through which the input shaft 16 with the connection interface 20 is guided out of the housing interior 19. The brake module 2 also has a sealing device 46 which is used for the fluid-tight sealing of the input shaft 16 with respect to the first housing part 151, the sealing device 46 being fixed to a sealing seat 47 of the first housing part 151. The sealing device 46 is designed as a rotary seal, in particular a radial shaft sealing ring.

Furthermore, the second housing part 152 has a shaft receptacle 45 in which the input shaft 16 is received within the housing interior 19. The brake module 2 also has a bearing device 48 which is used for the rotatable mounting of the input shaft 16 relative to the second housing part 152, the bearing device 48 being fixed to a bearing seat 49 of the second housing part 152. The bearing device 48 is designed as a friction-optimized deep groove ball bearing.

The fourth housing part 154 is in the form of a lid, and the fourth housing part 154 is inserted axially with respect to the axis of rotation 100 into the shaft receptacle 45 of the second housing part 152 in order to seal the housing interior 19 and to fix the bearing device 48 axially in the bearing seat 49. For fluid-tight sealing, an elastomeric sealing material, e.g. a rubber coating, is applied in the region between the second housing part 152 and the third housing part 153. In addition, the brake module 12 has a further securing means 50, e.g. a further retaining ring, by means of which the fourth housing part 154 is secured in the shaft receptacle 45.

In order to produce a cost-effective and easy-to-manufacture brake module 12, it is proposed that sheet metal components be used which are produced by shaping. For this purpose, the four housing parts 151, 152, 153, 154 are each designed as a sheet metal molded part. Furthermore, the two plate carriers 23, 24, the brake piston 29 and the two support parts 34, 35 can be designed as further sheet metal molded parts.

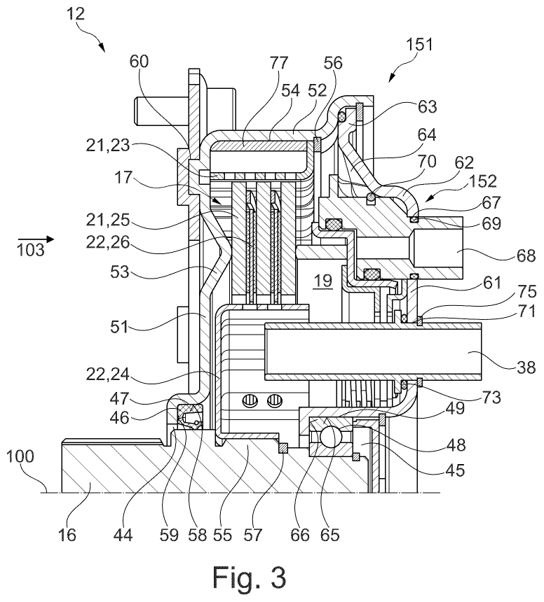

As shown in FIG. 3, the first housing part 151 has a pot base portion 51 and a pot wall portion 52. The pot base portion 51 extends in a radial plane of the axis of rotation 100 and the pot wall portion 52 directly adjoins the pot base portion 51 axially with respect to the axis of rotation. The first housing part 151 has a support contour 53 which is used for the axial support of the disk pack 25, 26, in particular one of the outer disks 25, the support contour 53 being introduced axially with respect to the axis of rotation 100 into the pot base portion 52 by shaping. For example, the support contour 53 can be formed by an elevation that runs around the axis of rotation 100.

Furthermore, the first housing part 151 has a connecting contour 54 which is used for the rotationally fixed connection of the outer disk carrier 23, the connecting contour 54 being introduced by shaping into the pot wall portion 52. Therefore, the input shaft 16 has a further connecting contour 55 at its outer circumference, which is used for the rotationally fixed connection of the inner disk carrier 24. For example, the connecting contour 54 and the further connecting contour 55 can each be formed by a tooth system that runs around the axis of rotation 100. The brake module 12 has two further securing means 56, 57, e.g. further retaining rings, which are used to axially secure the two disk carriers 23, 24 on the connecting contour 54, 55.

In addition, the sealing seat 47 is molded into the first housing part 151 by shaping in such a way that a radial contact surface 58 for the radial contact of the sealing device 46 and an axial contact surface 59 for the axial contact of the sealing device 46 are formed in the region of the shaft passage 44. For example, the sealing device 46 bears at least form-fittingly against the axial and radial contact surfaces 58, 59.

Furthermore, the first and third housing portions 151, 153 are connected to one another in the region of the pot base portion 51 by shaping. For this purpose, the first and third housing portions 151, 153 are connected to one another via a plurality of clinch connections 60 distributed circumferentially. The clinch connection 60 is designed in such a way that the braking torque can be introduced into the housing portion via complementary recesses in the housing portion of the drive machine 2 or the transmission gearing 3.

The second housing part 152 has a cylinder base portion 61, a cylinder wall portion 62 and a collar portion 63. The cylinder base portion 61 extends in a radial plane of the axis of rotation 100. The cylinder wall portion 62 directly adjoins the cylinder base portion 61 axially with respect to the axis of rotation 100 and the collar portion 63 in turn directly adjoins the cylinder wall portion 62 radially outwards.

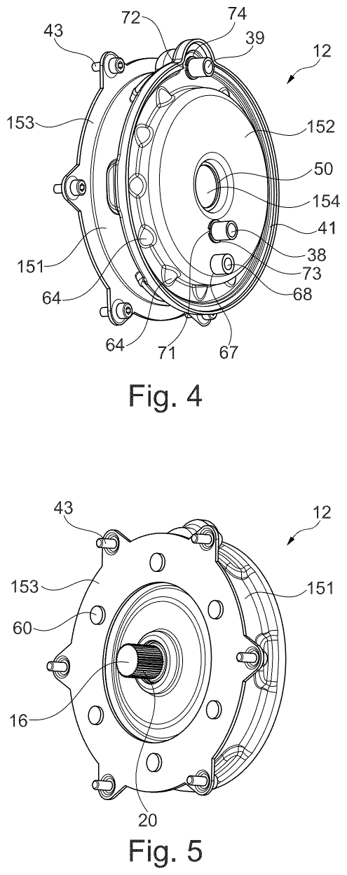

The second housing part 152 has a reinforcement contour 64 which is used to reinforce the second housing part 152, the reinforcement contour 64 being introduced by shaping into the collar portion 56 axially with respect to the axis of rotation 100 and at the same time is introduced by shaping into the cylinder wall portion 62 radially with respect to the axis of rotation 100. The reinforcement contour 64 is formed by a plurality of circumferentially distributed reinforcement ribs, as also shown in FIG. 4, in order to minimize the deformation of the second housing part 152 during axial loading.

In addition, the bearing seat 49 is molded into the first housing part 152 by shaping in such a way that a further radial contact surface 65 for the radial contact of the bearing device 48 and a further axial contact surface 66 for the axial contact of the bearing device 48 are formed in the region of the shaft receptacle 45. For example, the bearing device 48 bears at least form-fittingly against the axial and radial contact surfaces 65, 66.

The second housing part 152 has a receiving opening 67 which is used to receive a hydraulic connection 68 of the annular housing 28. For this purpose, the receiving opening 67 is introduced axially into the cylinder base portion 61, the hydraulic connection 68 being guided out of the housing 15 via the receiving opening 67. The hydraulic connection 68 is sealed in a fluid-tight manner with respect to the second housing part 152 by means of a further sealing ring 69 and is fixed to the cylinder wall portion 62 within the housing interior 19 by means of a further securing means 70, e.g. a further retaining ring.

Furthermore, the second housing part 152 has two further receiving openings 71, 72, as also shown in FIG. 4, which are used to receive the temperature-control inlet 38 and the temperature-control outlet 39. For this purpose, the further receiving openings 71, 72 are introduced axially into the cylinder base portion 61, and the temperature-control inlet 38 and the temperature-control outlet 39 are guided out of the housing 15 via the receiving openings 71, 72. The temperature-control inlet 38 and the temperature-control outlet 39 are each sealed in a fluid-tight manner with respect to the second housing part 152 by means of a further sealing ring 73, 74 and are each fixed to the cylinder base portion 61 outside the housing interior 19 by means of a further securing means 75, 76, e.g. a further retaining ring.

Optionally, the brake module 12 has an insulator 77 which is used for thermal insulation of the first housing part 151 in the region of the braking device 17. The insulator 77 is arranged on an inner circumference of the pot wall portion 52, and temperature-control fluid impinges on the insulator 77 when flowing through the outer disk carrier 23. For example, the insulator 77 is made of a material with low thermal conductivity, e.g. a plastic, which can reduce heat losses to the housing 15 and thus to the surroundings.

FIGS. 3 and 4 show the brake module 12 in a front and a rear view, and the brake module 12 is designed as a separate, encapsulated or fluid-tight enclosed structural unit. This embodiment allows the brake module 12 to be operated without emissions and avoids the escape of fine dust particles, since these are bound in particular by the temperature-control fluid.

### REFERENCE NUMERALS

1 Drive arrangement
2 Drive machine
3 Transmission gearing
4 Wheels
5 Axle
6 Differential
7 Stator
8 Rotor
9 Rotor shaft
10 Transmission input
11 Transmission output
12 Brake module
13 Service brake
14 Recuperation brake
15 Housing
16 Input shaft
17 Braking device
18 Actuating device
19 Housing interior
20 Connection interface
21 First braking partner
22 Second braking partner
23 Outer disk carrier
24 Inner disk carrier
25 Outer disks
26 Inner disks
27 Return springs
28 Annular housing
29 Annular piston
30 Pressure chamber
31 Pressure piece
32 Piston seal rings
33 Return unit
34 First support part
35 Second support part
36 Connecting elements
37 Spring elements
38 Temperature-control inlet
39 Temperature-control outlet
40 Fluid openings
41 Securing means
42 Sealing ring
43 Fastening means
44 Shaft passage
45 Shaft receptacle
46 Sealing device
47 Sealing seat
48 Bearing device
49 Bearing seat
50 Securing means
51 Pot base portion
52 Pot wall portion
53 Support contour
54 Connecting contour
55 Further connecting contour
56 Securing means
57 Securing means
58 Radial contact surface
59 Axial contact surface
60 Clinch connection
61 Cylinder base portion
62 Cylinder wall portion
63 Collar portion
64 Reinforcement contour
65 Radial contact surface
66 Axial contact surface
67 Receiving opening
68 Hydraulic connection
69 Sealing ring
70 Securing means
71 Receiving opening
72 Receiving opening
73 Sealing ring
74 Sealing ring
75 Securing means
76 Securing means
77 Insulator
100 Axis of rotation
101 Drive torque path
102 Braking torque path
103 Return force
104 Axial force
151 First housing part
152 Second housing part
153 Third housing part
154 Fourth housing part

1. A brake module for an electric drive train of a vehicle, comprising:
an input shaft for integrating the brake module into the drive train, wherein the input shaft is rotatably mounted about an axis of rotation,
a braking device for generating a braking torque, wherein the braking device has a first braking partner and a second braking partner, wherein the first braking partner is arranged so as to be stationary in the brake module and the second braking partner is connected for conjoint rotation with the input shaft,
a hydraulic actuating device for actuating the braking device,
a multi-part housing for receiving the input shaft, the braking device and the actuating device, wherein the housing has a pot-shaped first housing part and a lid-type second housing part which covers the first housing part at least partially, wherein
the first housing part and the second housing parts are each designed as a sheet metal molded part.

2. The brake module according to claim 1, wherein, on the first housing part:
a support contour for axially supporting the first braking partner or the second braking partner is formed by shaping; or
a connecting contour for a rotationally fixed connection of the first braking partner is formed by shaping.

3. The brake module according to claim 1, wherein a reinforcement contour for reinforcing the second housing part is formed on the second housing part by shaping.

4. The brake module according to claim 1, further comprising at least one sealing device for fluid-tight sealing of the input shaft with respect to the housing, wherein a sealing seat for the sealing device is formed by shaping on the first housing part or the second housing part.

5. The brake module according to claim 1, further comprising at least one bearing device for rotatably mounting the input shaft relative to the housing, wherein a bearing seat for the bearing device is formed by shaping on the first housing part or the second housing part.

6. The brake module according to claim 1, further comprising a flange-like third housing part for fastening the housing to a component of the drive train, wherein the third housing part is designed as a sheet metal molded part or is connected to the first housing part by shaping.

7. The brake module according to claim 1, wherein the second housing part has a shaft receptacle for partially receiving the input shaft, wherein the brake module has a lid-type fourth housing part for sealing the shaft receptacle, and the fourth housing part is designed as a sheet metal molded part.

8. The brake module according to claim 1, wherein the braking device is designed as a multi-disk brake, wherein
the first braking partner has an outer disk carrier having a plurality of outer disks, wherein the outer disk carrier is designed as a sheet metal molded part, or
the second braking partner has an inner disk carrier having a plurality of inner disks, wherein the inner disk carrier is designed as a sheet metal molded part.

9. The brake module according to claim 1, wherein the actuating device has an annular housing and an annular piston which is axially movable with respect to the axis of rotation, wherein a pressure chamber is formed between the annular housing and the annular piston so that, when a hydraulic fluid is supplied into the pressure chamber, an axial force can be transmitted via the annular piston to the braking partners, wherein the actuating piston is designed as a sheet metal molded part.

10. An electric drive train of a vehicle, comprising:
an electric drive machine for driving at least one vehicle wheel, wherein the drive machine has a stator and a rotor, and
the brake module of claim 1, wherein the rotor is connected at least indirectly to the input shaft of the brake module in a torque-transmitting manner.

11. A brake module, comprising:
an axis of rotation;
a multi-part housing, comprising:
a first housing part, designed as a sheet metal molded part having a pot shape; and
a second housing part, at least partially covering the first housing part and designed as a sheet metal molded part having a lid shape.
an input shaft arranged in the multi-part housing and rotatably mounted about the axis of rotation;
a braking device arranged in the multi-part housing and comprising:
a first braking partner arranged stationary; and
a second braking partner arranged to rotate with the input shaft; and
a hydraulic actuating device arranged in the multi-part housing for actuating the braking device.

12. The brake module of claim 11, wherein the first housing part comprises:
a support contour formed by shaping for axially supporting the first braking partner or the second braking partner; or
a connecting contour formed by shaping for rotationally fixed connection of the first braking partner.

13. The brake module of claim 11, wherein the second housing part comprises a reinforcement contour formed by shaping for reinforcing the second housing part.

14. The brake module of claim 11, further comprising a sealing device for fluid-tight sealing of the input shaft to the multi-part housing, wherein:
the first housing part comprises a sealing seat formed by shaping for the sealing device; or
the second housing part comprises a sealing seat formed by shaping for the sealing device.

15. The brake module of claim 11, further comprising a bearing device for rotatably mounting the input shaft in the multi-part housing, wherein:
the first housing part comprises a bearing seat formed by shaping for the bearing device; or
the second housing part comprises a bearing seat formed by shaping for the bearing device.

16. The brake module of claim 11, wherein the multi-part housing further comprises a third housing part designed as a sheet metal molded part having a flange-like shape and arranged for fastening the multi-part housing to a drive train component.

17. The brake module of claim 11, wherein:
the second housing part comprises a shaft receptacle for partially receiving the input shaft; and
the multi-part housing further comprises a fourth housing part designed as a sheet metal molded part having a lid shape for sealing the shaft receptacle.

18. The brake module of claim 11, wherein:
the braking device is designed as a multi-disk brake;
the first braking partner comprises an outer disk carrier, designed as a sheet metal molded part, and a plurality of outer disks; or
the second braking partner comprises an inner disk carrier, designed as a sheet metal molded part, and a plurality of inner disks.

19. The brake module of claim 11, wherein:
the hydraulic actuating device comprises:
an annular housing;
an annular piston, designed as a sheet metal molded part and axially movable relative to the axis of rotation; and
a pressure chamber formed between the annular housing and the annular piston so that, when a hydraulic fluid is supplied to the pressure chamber, an axial force can be transmitted via the annular piston to the first braking partner and the second braking partner.
